(19) United States
(12) Patent Application Publication
(10) Pub. No.: US 2014/0101611 A1
(43) Pub. Date: Apr. 10, 2014

(54) Mobile Device And Method For Using The Mobile Device

(71) Applicants: Andrew K. LANG, New York, NY (US); Steven SPENCER, New York, NY (US); Josh WOLFF, New York, NY (US)

(72) Inventors: Andrew K. LANG, New York, NY (US); Steven SPENCER, New York, NY (US); Josh WOLFF, New York, NY (US)

(73) Assignee: Vringo Lab, Inc.

(21) Appl. No.: 14/048,965

(22) Filed: Oct. 8, 2013

Related U.S. Application Data
(60) Provisional application No. 61/711,025, filed on Oct. 8, 2012.
(60) Provisional application No. 61/711,043, filed on Oct. 8, 2012.
(60) Provisional application No. 61/711,646, filed on Oct. 9, 2012.
(60) Provisional application No. 61/712,685, filed on Oct. 11, 2012.
(60) Provisional application No. 61/712,687, filed on Oct. 11, 2012.
(60) Provisional application No. 61/713,190, filed on Oct. 12, 2012.
(60) Provisional application No. 61/713,215, filed on Oct. 12, 2012.

(51) Int. Cl. G06F 3/0484; H04L 29/08

(52) U.S. Cl. CPC G06F 3/04842; H04L 67/22
USPC 715/813; 709/204

(57) ABSTRACT

A device and method for operating the device that includes verifying a user, managing communication priorities, predicting application use, rewarding the user for device activity, posting social media status updates, and enhancing sleep patterns.

### CROSS REFERENCE TO RELATED APPLICATIONS

This application claims priority from U.S. Provisional Patent Application Ser. No. 61/711,025 which was filed on Oct. 8, 2012; U.S. Provisional Patent Application Ser. No. 61/711,043 which was filed on Oct. 8, 2012; U.S. Provisional Patent Application Ser. No. 61/712,687 which was filed on Oct. 11, 2012; U.S. Provisional Patent Application Ser. No. 61/712,685 which was filed on Oct. 11, 2012; U.S. Provisional Patent Application Ser. No. 61/713,190 which was filed on Oct. 12, 2012; U.S. Provisional Patent Application Ser. No. 61/713,215 which was filed on Oct. 12, 2012; and U.S. Provisional Patent Application Ser. No. 61/711,646 which was filed on Oct. 12, 2012, the entirety of each incorporated herein by reference.

### BACKGROUND OF THE INVENTION

1. Field of the Invention

The present invention relates to using a mobile device, from initially unlocking it until a user goes to sleep at night.

The present invention is directed to using 2D facial recognition to unlock a device such as a smartphone, tablet, or the like or a specific application, while not requiring a full 3D facial recognition system. Once the device is unlocked, the present invention is a system and method for deriving a user's current status with respect to receiving communications and preferences for various forms of notifications that a communication is being sought with the user by an originator. The originator is categorized into a priority class with respect to the specific user and the originator may indicate a relative priority level for a specific communication being sought. The system decides, based at least in part on these factors, a form of signaling and a level of intrusiveness (including none) to use to alert the user that a communication is being sought, and how to initiate the communication setup with the originator to let them know the status and results of their communication request in a socially acceptable manner.

The unlocked device is configured to implement a method for monitoring and recording device activity. The activity includes specific applications launched, used, and activated, telephone calls, text messaging patterns, GPS/location, browsers launched, and the like. The overall device usage establishes a pattern of use based on time, day, location, other available contextual data, and recent user activity. As the predictor application records the various device and user activities a predictive model of use is created and the application then makes intelligent recommendations to the user for which application is most likely to be needed next.

The present invention also relates to device usage and more particularly to rewarding a user's specific wireless device activity.

One particular activity may involve social media. The device functions as a system and corresponding method for determining content relevance and interest by having a user vote like or dislike and limiting provided content to relevant content and more specifically a system and method for learning a user's private social ordering and mediating communications and other social activities in accordance with the user's private social ordering.

One particular application is an application for the management of smartphone and tablet devices that provides a parent mode for applications and a sleep inducement function.

2. Related Art

Problems with 2D facial recognition are well known. The Android App Store has several 2D facial recognition security apps that can be easily defeated with a photo that is a likeness of the original secure image.

Those in the field are addressing this problem by creating full 3D facial recognition algorithm. Presently, cameras for mobile devices can recreate 3D models of scanned objects as well as capture gestures and facial expressions. The algorithm uses both stills and video and employs one or more dedicated cameras to capture 3D objects. Additionally, depth-detection sensors, such as LIDAR, RADAR, and laser, create stereo disparity maps in 3D imagery.

The three-dimensional imaging apparatus may be used for recognizing facial gestures. Facial gestures may include, but are not limited to, smiling, grimacing, frowning, winking, and so on and so forth. In one embodiment, this may be accomplished by detecting the orientation of various facial muscles using surface geometry data, such as the mouth, eyes, nose, forehead, cheeks, and so on, and correlating the detected orientations with various gestures. This solution requires significant computational capabilities and complex hardware.

Whether locked or not, there is a problem of not receiving an urgent call while a mobile phone or other communication device is placed in silent or vibrate mode. This issue is well acknowledged and has existed for over 10 years. One solution that has been used is a white list of VIP numbers that allow the logic in a mobile phone to automatically turn on its ringer for a specific set of numbers. This solution is inadequate because it does not allow the calling party to exercise any judgment with respect to the relative importance of their call. Additionally, the present white list solution does not incorporate learning logic that helps a user's device learn an appropriate disposition for certain callers based on a target's state.

The present in invention provides a system and method including an adaptive learning algorithm to auto adjust the device settings, and to start applications based on the user's usage pattern. The present invention is an improvement over the existing methodology of manually setting a profile, or hunting for the needed application across a large collection of applications.

In a preferred embodiment of the invention, the device profile is adapted to suggest the next application to use based on actual usage patterns and learns from the user behavior. In other words, the present system and method is generally considered an AI (artificial intelligence) system that learns and adapts with use.

In a preferred embodiment, each function that can be performed by the device can be controlled and launched as required.

In a system or device embodying the present invention, there is a time that it takes to learn a user's activity pattern. To mitigate the learning time, the method of learning application activation is combined with the existing art to allow the user to jump-start the process by making manual settings, or by learning from habits of other users deemed similar to the present user. In this manner, the learning curve for the application and system embodying the application is reduced.

In a preferred embodiment of the invention, a client side application is provided as mobile software that operates in conjunction with server-side functions.

There are various reward programs for smartphone use. Each of these programs has almost always focused on an advertising event that is one of a text, a banner, or a video. After delivery of the advertising event, the user is rewarded for advertising or commerce activity.

Current social media sites, news sites, music sites, and the like, provide a user with too much noise, including posts that are not of interest to the user. This has been a problem since inception of such sites, particularly social media sites. There are some ways to handle unwanted content. For example, Facebook allows users to modify the frequency of all posts from a user from “All”, to “Important”, to “Some”, or “None”. In other networks, your choices are to “unfriend” or “unfollow” a specific user. A similar concept is used for music selection with Pandora. Presently there is no effective way to limit content to eliminate the unwanted content.

The use of a smartphone application as an aid to falling asleep has been in the commercial space for at least 5 years. The existing applications tend to be variations of specific music tracks, nature sounds, or other rhythmic sounds. These applications are activated once you decide you want to go to sleep. There are no applications that measure and manage the effect of the vast library of non-sleep specific applications on a user's sleep cycle. For example, is playing a solo game of Scrabble at bedtime more sleep inducing than a first person shooter?

### SUMMARY OF THE INVENTION

According to one embodiment of the invention, 2D facial recognition is enhanced to unlock a device (such as a smartphone or tablet) or specific applications, while not requiring a full 3D facial recognition system.

One embodiment of the invention combines 2D facial recognition with 3D image detection, which prevents overcoming pure 2D facial recognition with a photograph.

A representation of the authorized users (AUTHUSER) face or other selected image is stored in the device as an image, a set of images, or a model or set of key recognition metrics for comparison through the camera of the person seeking access to the device to unlock the whole device, certain functions of the device or specific apps.

The key enhancement to the existing art is a set of methods to determine that the image that the device is evaluating is a live (actual) person and not a photographic image or replica of the authorized user intended to defeat the security of the device.

In one embodiment, the present method is incorporated into a 2D facial biometric security system.

One embodiment of the invention is a new use of text/call interaction and feedback to selectively turn on a mobile ringer or other notification under certain controlled circumstances. In particular, the decision is based in part on a caller's judgment in the process.

In one embodiment, the proposed solution permits the originating caller (Originator), listed on a high priority list, to exercise judgment either by sending a VIP text alert prior to the call or by responding to the missed call with a text message that will turn on the ringer. The Originator can thus decide if the call is worthy of interrupting, waking up, or disturbing the user. Callers of lesser priority are disposed of in appropriate manners, without the capability to turn on a silenced ringer or otherwise disturb the user.

According to one embodiment of the invention, arming of the ringer is based on a priority ranked list, identification of a state of the user's phone, matching disposition logic, explicit, implicit, and learned behavioral state setting, an information sharing setting, communication modalities, and set-up wizard logic, whereas the prior art arms the ringer based solely on a white list.

According to one embodiment of the invention, a mobile phone can be reached in the event of a true emergency if that phone does not have its ringer armed, while not disturbing the user if this is not an urgent call.

One embodiment of the invention is created primarily with Client side (Mobile) software. Server-side software can be utilized when the calling party is using a non-mobile phone or sending an instant message from a computer. For a mobile smartphone, tablet device, or the like, the application resides on the Smartphone device in a computer readable medium for setting and managing priorities, phone state, disposition and feedback logic and detecting calls from same, sending and receiving of “arming” text messages. For a Web Based solution, the application resides as a Web site application to intercept white listed calls and manage a voice interactive system with the calling party and mange the sending/receiving of text messages with the called party, and completing the call if required. For example, a voice-over-internet-protocol (VoIP) might utilize a web-based solution.

In one embodiment, the application provides an emergency alert system (i.e., a reverse 911 function). The alert can be broadcast to a single user, a list of specific users, or a global user broadcast.

One embodiment of the present in invention provides a system and method including an adaptive learning algorithm to auto adjust the device settings, and to start applications based on the user's usage pattern. The present invention is an improvement over the existing methodology of manually setting a profile, or hunting for the needed application across a large collection of applications.

In a preferred embodiment of the invention, the device profile is adapted to suggest the next application to use based on actual usage patterns and learns from the user behavior. In other words, the present system and method is generally considered an AI (artificial intelligence) system that learns and adapts with use.

In a preferred embodiment, each function that can be performed by the device can be controlled and launched as required.

In a system or device embodying the present invention, there is a time that it takes to learn a user's activity pattern. To mitigate the learning time, the method of learning application activation is combined with the existing art to allow the user to jump-start the process by making manual settings, or by learning from habits of other users deemed similar to the present user. In this manner, the learning curve for the application and system embodying the application is reduced.

In a preferred embodiment of the invention, a client side application is provided as mobile software that operates in conjunction with server-side functions.

According to one embodiment of the invention, a phone call is a trigger for a reward because there is some value to a party for the making and receiving of phone calls from a mobile smartphone. An application detects all mobile originated and mobile terminated calls on a smartphone or other wireless device. Once the call is detected the application sends a message to a central server that registers this event. The message is sent via the phone's internet connection, not the existing mobile signaling path that actually manages call control. The purpose of registering these events is to reward the consumer with “points” for each qualifying call event. It should be noted that while the preferred embodiment is disclosed with respect to a regular carrier voice call, qualifying communications can include SMS, MMS, VoIP Service, Video Call, Video Message, Voice Message, Voice Alert, push to talk, or the like.

One embodiment of the invention is a method of determining relevance and interest by having a user vote like or dislike.

This present invention differs from existing social media filtering mechanisms in that it determines a user's desire to view similar posts by analyzing like/dislike choices. The present application monitors like/dislike choices to moderate which posts and stories are presented for viewing.

The application learns a user's private social ordering and mediates communications and other social activities in accordance with the user's social ordering. The present application monitors the user's private social ordering and moderates which posts and stories are presented for viewing.

Once you become “friends” with someone in a social network, you are subject to all of their posts, regardless of their relevance or interest. The present application solves the problem of social media overload and noise by allowing stories or posts that are determined as being of interest to the user to be posted to the user based on the user's likes and dislikes. In a preferred embodiment, when a user selects dislike this designation is not made available to the original poster, thereby avoiding any social stigma with respect to the dislike vote. Importantly, the vote of “dislike” is private so that it is not made available to the original poster. The dislike vote does not create a social stigma and does not hinder the “real-world” relationship between the poster and the viewer of the post.

This invention permits the social networks to learn a user's preferences for posters and subjects and then gives more preference to those persons and topics. The application will, in time, reduce the “noise” of the user's social networks and provide a more targeted feed of information that matches the user's preferences and private social ordering.

An embodiment of the present invention is a new application/service that is an enhancement of smartphone and server application capabilities.

Voice communications using traditional mobile devices is an activity that occurs without participating in social media. The “disconnect” between voice communications and social media communications has existed since the earliest days of social media. The communication disconnect between voice communications and social media communications is presently solved by a user launching a social media application immediately following a phone call and then authoring a status update. This two-step process of leaving a phone call session and launching the social media app has proven to be a significant barrier to users posting about their phone calls.

The invention provides an automated and easy approach to posting to social media sites immediately after a phone call in a single step user flow.

The detection of the post call event is accomplished using a Vringo technology used in the Facetones product. In Facetones the post call event triggers a call to an advertising network to display an ad. In this invention the post call event triggers an application to launch templates for creating and auto-posting a status to social media sites. In other words, the app launches a FaceBook status template, a tweet template, or the like.

The invention differs from existing technology in that it creates a social media linkage between a mobile phone call and posting to social media sites. This direct application linkage streamlines the process of posting to social media sites immediately following a phone call and will result in a greater volume of posts, and more timely posts.

The present application monitors and measures application usage prior to a user falling asleep. The application selectively monitors other applications at a specific time of night and determines, by device inactivity, when the user has fallen asleep. This monitored application data is used to determine a user profile for the best apps to use when the user wants to fall asleep quicker.

In one embodiment of the invention, the application is the basis for an application rating system for sleep inducement.

This application is installed on a smartphone or tablet and activated to maintain the monitoring function. Alternatively, the application is resident on a server that is accessed by the smartphone or tablet over a network. In one embodiment, the application is primarily client side (mobile) software coupled with a centralized server database.

In one embodiment, the invention is configured as a mobile smartphone or tablet application that resides on a smartphone device. The application manages monitoring and measurement of applications that are active based a provisioned “bed time” (i.e. 10:00 pm). The application communicates monitored measurements with a centralized server for data analysis.

### BRIEF DESCRIPTION OF THE FIGURES

FIG. 1 is a flowchart for storing a secured image;

FIG. 2 is a flowchart for 3D image detection;

FIG. 3 is a flow diagram for a call followed by a text;

FIG. 4 is a flow diagram for a text followed by a call;

FIG. 5 is a flow diagram for a white list call back;

FIG. 6 is a flow diagram for a network intercept;

FIG. 7 is a decision tree for notification;

FIG. 8 is a flow diagram for an embodiment of the invention;

FIG. 9 is a flow diagram for an application predictor;

FIG. 10 is a flow diagram for an incoming call;

FIG. 11 is a flow diagram for a reward request;

FIG. 12 is a flowchart for determining item relevance and interest by having a user vote like or dislike;

FIG. 13 is a flowchart for posting call events to social media;

FIG. 14 is a flow diagram; and

FIG. 15 is a system diagram.

### DETAILED DESCRIPTION OF THE PRESENTLY PREFERRED EMBODIMENTS

People use mobile devices all of the time. From the time they wake until they go to bed, their devices are in use. This makes mobile devices an integral part of a person's life. The mobile device has to be secure to protect a user's information. The device protects the information by providing a locking function. Ideally, the device also assists in selecting applications that are used, notify the user of important events or calls, and reward a user for specific activities. Finally, at the end of the day, the device should assist the user in easily falling asleep.

Presently, mobile devices are more than just cellular telephones. Mobile devices are smartphones that contain a large amount of a user's data. These devices include smartphones, tablets, computers, and the like. These devices generally have a display, a processor, memory, and an input device. Many times, the input device is part of the display, configured as a touchscreen. Alternatively, a separate physical keyboard can be provided. This data includes contacts, photographs, documents, and the like. Additionally, because many applications can be used on these smartphones, passwords and usernames are typically stored on these smartphones. To prevent unwanted or unauthorized access to the mobile device, typically users add an electronic lock to the mobile device.

In one embodiment, a representation of an authorized users face (AUTHUSER) is stored in the device as an image, a set of images, a model, or set of key recognition metrics for comparison through the camera of the person seeking access to the device to unlock the whole device, certain functions of the device or specific apps. In other embodiments, appendages such as hands, or a pet can be used. The present method provides a way to determine that the image that the device is evaluating is a live (actual) person and not a photographic image or replica of the authorized user intended to defeat the security of the device.

To determine the authenticity of the image taken by a camera, the system performs one or more of the following steps. Initially, an image for AUTHUSER is stored in a system memory or is accessible over a network in a secure manner. A match between AUTHUSER and the camera image is determined using any standard available facial recognition algorithm. If the images match at a sufficient threshold of confidence then use one or more of the following methods is used to authenticate that a security-defeating replica is not being employed.

In a preferred embodiment, a device has a microprocessor, a memory, a camera, and at least one of a display and an auditory output. In one embodiment, the device further comprises a transceiver. A picture is taken, stored, and then used as the basis for the authentication.

In a first method, the user is instructed via the device to “slide to unlock” the device (i.e. move the entire device as opposed to slide a widget on a touchscreen) up, down, and/or to either side while keeping their face centered in the view of the camera. Alternatively, the user is instructed to turn their head up, down, and/or to either side while keeping their face in range of the camera. In one embodiment, specific patterns are to be followed for the unlocking motion.

By comparing the set of images captured from different angles, the system can determine if the camera image is a 2D or 3D image. The 3D nature of the camera image can be determined by measuring relative distances for different images from points on the mouth, nose and eyes and other easily determined (via standard algorithms) visual “landmarks”. The relative distances will change in an image based on the angle or position of the camera to the face and the third dimensional distance/depth of the landmark. For example, the ratio of distances from the tip of the nose to each pupil will change as the user turns their head to the side due to geometrical principles—the nose projects outward from the face relative to the depth of the pupils.

In a second embodiment, cues from shadowing and brightness are used for different captured images to determine if an image is 3D. In an environment in which the user and device are not overwhelmed by ambient light (such as bright sunlight), the device can be held close to the users face, and the touchscreen display can turn any half of the screen total white and the other half total dark. This will create for the moment differences in shadow and highlight on a three-dimensional face that won't happen in a similar way to a two dimensional replica. For example, if the left half of the screen is white, and it is held close to the users face then the left side of the user's nose will be brighter than the right side. Multiple up/down/left/right halves can be rapidly lit up and relative brightness effects quickly analyzed as they are captured by the camera to determine whether it is a flat photo or a three dimensional genuine face.

In a brightly lit environment such as outdoors in the sun (the device can determine the ambient light level using a sensor or the camera), the user can be asked by the device to remain facing the camera head on while turning around and as the camera revolves around the person, the shadows and highlights will also change on a three dimensional face with the angle of the direct light source (such as the sun) but not a two dimensional photo. For example, just like a sundial, the user's nose will block the sun to part of the face at some angles but not others, causing relative changes in brightness as the user turns around.

In a third embodiment, the system instructs a user to perform a facial gesture such as winking, smiling, opening the mouth, etc. and observe that it's not a static image in the camera but is smoothly changing in the correct responsive manner.

It is generally recognized in the security industry that there is often a tradeoff between convenience of the authentication methods and the level of security provided and/or cost of defeating the security. In addition to the above methods being used in combination for added security, challenge/response techniques can be used to require the user to do unique patterns that cannot easily be replicated by a fixed video of the authorized user performing the authentication procedure. For example, a rapid succession of the tests in Method 2 in a random sequence with random timing can be used. Unless the party wishing the defeat the security can completely model the AUTHUSER in 3 dimensions and use this model to respond appropriately to randomly chosen and timed 3 dimensional tests using a live display, or can make a full and accurate 3D mask of the AUTHUSER that can respond correctly, this would be very difficult and expensive to defeat.

If the image is determined to be 3D, then this information, along with the 2D match will be deemed a secure match.

This method is simpler and less computationally intensive than a full 3D facial recognition algorithm and likewise utilizes less computing power of a microprocessor.

A common method used today to unlock a phone or other device is typing in a code, typically a 4-digit number. It is common knowledge that these are easily observed by anyone nearby, or can be observed further away using a telephoto lens and recorded. The present method can also employ this more familiar method as a backup in case there are any problems with the methods described (such as, for example, if a disfiguring accident happened to the authorized user). For example, the user remembers and enters a four-digit pin code. However, the invention provides for an extra high-security option for doing this code entry in case there is even the slightest chance it might be observed in the immediate environment and the security requirements of the user are sufficiently high to warrant the added complexity of the demands on the user.

In an embodiment using a personal identification number (PIN), assuming the mobile device has phone-like characteristics for this method, the user holds the phone up to their ear, and the phone requests the user speak each digit of their PIN code, except after transforming the digit by adding a random digit, a shift-by amount, given by the device modulo 10. For example, if the device says “3”, and the next digit of the PIN code is 5, the user says “8”. If the device says “7”, and the next digit of the PIN code is “7”, the user says “4”. Other formats or mathematical functions can also be employed. Alternatively, the device can display the shift-by amount for the user to enter the shifted value.

Using this high security PIN code entry method, the user cannot be observed typing in their code, nor will the user's voice speaking the digits reveal any information about their code to anyone able to listen either nearby or remotely. Further, most users will be able to do the digit transformation without too much difficulty (especially with practice) since it is very simple arithmetic. The device can also be set to use this mode exclusively if there is any concern that the other methods described herein might be successfully defeated.

In alternative embodiments, the proposed security method can be used for tablet and PC security, building access security, account access security, application access security, vehicle security, set top box security (alternative to PIN security), and ATM security.

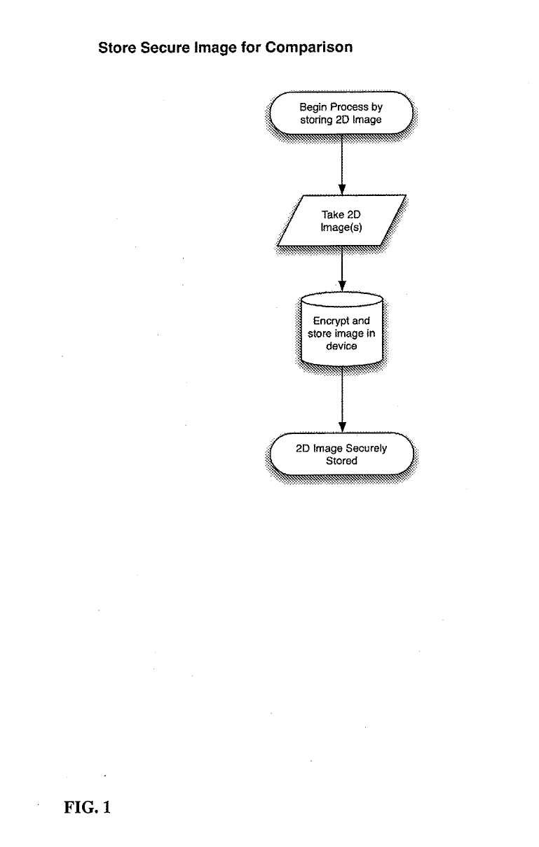

FIG. 1 is a flowchart of an embodiment of the invention. Initially, the mobile device takes and stores an image. Presently, most mobile devices are only able to capture 2D images. It should be noted that this unlocking method could be implemented with 3D images as well. The captured 2D image is stored in the device. Preferably, the image is encrypted prior to being stored.

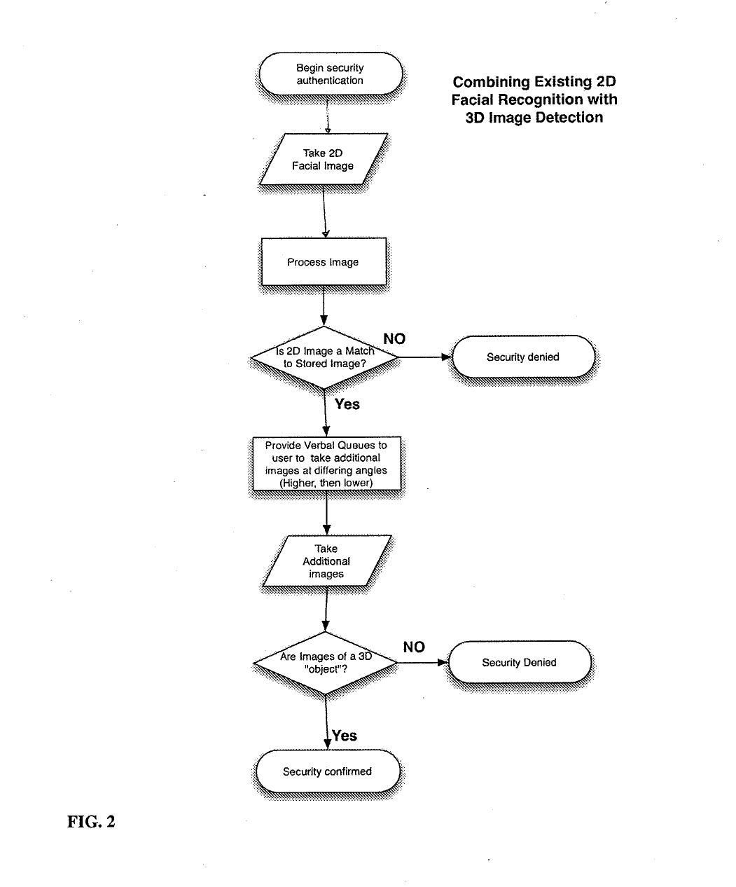

FIG. 2 is a flowchart for unlocking the mobile device. The security authorization program begins by capturing a 2D image. The 2D image is processed and compared to the stored 2D image. If the images do not match, security is denied. If the images match, cues are provided for subsequent security processing. In particular, verbal or text cues are provided to capture additional 2D images. The mobile device analyzes the additional 2D images to confirm that the images are a 3D object. If the image cannot be confirmed as a 3D object, security is denied. If the image is confirmed as a 3D object, the security authorization program allows access to the device.

Once the mobile device is accessible to the user, the user may choose to modify or vary the manner in which calls or other communications are received. In general, the embodiments are referred to as calls and callers, but this is meant to be a general term that encompasses any form of communication on a mobile device and the originator of that communication request. It should be noted that other devices, other than mobile devices, also come within the scope of the present disclosure.

One embodiment of the present invention provides a system for deriving a user's current context with regard to receiving communications and corresponding preferences for that user's forms of being signaled that an originator is seeking a communication with them. The originator is categorized into a priority class with respect to the specific user, and the originator may indicate a relative priority level to a specific communication being sought. Based at least in part on the originator priority class and the message priority, the system decides a level of intrusiveness (including none) to use to alert the user that a communication is being sought, and how to initiate the communication setup with the originator. The system lets the user, and possibly the originator, a status and result of the communication request in a socially acceptable manner.

This concept advances the state of the art from implementing such a feature through a pre-programmed white list on the phone of the party receiving the call. In one embodiment, the user side application is able to decline calls with a text message back, set a reminder to call the person back, set a do not disturb mode either manually or according to a schedule, and allow callers to override a setting by either being on a favorites list or by calling repeatedly within a time interval.

There are generally five (5) interrelated decisions or elements utilized for call management; they are creating priority classes, determining user status, matching user and originator states, information sharing, and determining communication modalities.

Creation and Separation of Callers into Specific Priority Classes.

Caller Priority Classes can be several levels or distinct types ranging from high priority to low priority. Alternatively, the priority class is a binary function, either high or low priority.

Callers, referred to interchangeably as originators, that call a specific person, referred to interchangeably as a user or target, are divided according to priority class. The mechanism for class creation can include, but is not limited to, explicit settings and classes derived from information known or unknown about the originator. The user's device allows the user to explicitly set the priority class of any calling party in the contact list. Additionally, a user can set a priority class for any individual that is not in their contact list. For example originators can be in distinct classes based on explicitly defined criteria, or a ranked set of such classes such as:
a) Caller ID blocked or anonymous communications gets lowest priority;
b) Originators from out of the country get next lowest;
c) Callers from toll free numbers;
d) Callers from out of state or out of area code;
e) Local callers, but still not recognized by the device as ever having communicated before;
f) Callers that have communicated with the user before;
g) Callers that have been added to the users contact list; and
h) Callers that have been “favorited” by the user, or put into other special categories explicitly.

In one embodiment of the invention, the priority is auto-set based on a previous call. Following completion of a call, the application on the user's phone can request that the user set a priority class for that specific originator's number at that moment. Alternatively or additionally, priority class for an email address, instant message name, or the like can be set.

In one embodiment, the priority is a learned adjustment to a priority class setting. If a specific originator calls the target's phone often with the target user completing the call “often”, in other words, multiple calls that are typically answered, then the logic of the application can increase that originator's priority. Likewise, if calls from a specific number of an originator are rarely answered, then its priority will be decreased by the application.

The application can share social priority. The originator can share a relative priority it has established for a called target phone within intra-application communication between devices. The target may establish a rule that considers an originator's reciprocal priority setting in their (the target's) priority rating of that originator. Also, via aggregating such priorities across users (in a secure and private manner) overall priority ratings can be derived that help initially determine the priority class of an originator that has never been in contact with a specific user before. For example, a very respected originator, or an originator with typically very valuable or important information to convey (such as a medical doctor) could automatically get a higher initial priority class for a newly contacted user because past targets have put the doctor in a high priority class. Similarly, an abusive or annoying person (perhaps an illegal telemarketer) might get automatically downgraded in priority for a new user they seek to communicate with.

2. Identification of the Target (Receiving) Party's State is Defined.

The definition of state includes both explicit and inferred state information, which includes, but is not limited to:
a) Location as determined by GPS or WiFi location techniques;
b) Context as determined by an explicit setting by the user on the phone. For example clicking an option that indicates that you are at work, or sleeping, watching a movie, in a meeting, driving, or the like;
c) Travel State as determined by GPS with speed indication, location information that indicates the user is between home and work, or at a location that is more than X miles from home;
d) Schedule, as determined by reading the user's calendar information for busy times, explicit settings for home, work, vacation, not available, sleep, etc.;
e) Application Status: Active use of specific applications can be used to derive the state of the target's device, either explicitly or implicitly. For example, the target user could place his/her phone in a not available state when a specific application is active. The application can also derive state information over time by detecting how the target user reacts to various communications when certain applications are active. For example, a user may deactivate communication settings or ignore calls when an e-reader application is being used.
f) Device accelerometer, charging state, light detection, and Bluetooth: The combination of movement detection, charging state, Bluetooth use, and light detection can be used to further derive phone states. For example: The combination of movement detection, no charging, and no light detected could place the device in a state that is in the target user's pocket or bag while the target user is in transit (Walking). A combination of no light, no motion, with charging would place the state on a desk or night table (based on other available information such as location). The detection of Bluetooth with a device velocity of 55 MPH would indicate a state of being in an automobile.

It should be noted that while the identification and management of device state, and the intermediation of the communication request can take place at the mobile device, it can also take place at the carrier or a third party server level. For example, the device can communicate its GPS location and if device signal disappears, the carrier network can notice that it happened at a subway entrance and derive what the new context is from that. The carrier can also deduce location using cell site triangulation. In one embodiment, the charge state being low can be communicated to the carrier so that it can determine the issue being that the device has completely discharged if it goes off line or has insufficient power to activate the transceiver. Another example would be if the carrier network detects the location of the target as entering an area with poor or no cell reception. Each of these cases can be handled at the carrier level, with estimations made by the carrier of when the target might be available again based on historical data, and enabling the originator to be notified of what happened if the target's priority/privacy settings allow for that originator to receive such information about the target.

3. Matching Logic for Originator's Priority Setting with Identification of Target Party's State.

The application has a logic map to determine the proper disposition of a communication request based on the originators priority and the willingness of the target to accept calls from the originator. Examples of disposition when the target is identified to be in “don't alert me unless it is really important context” are:
a) Always ring phone in increasingly louder levels for calling users of this priority (Highest Level);
b) Do Not ring phone for users of a priority (High), and give explicit information in a message to the calling party on exactly what the Target users “state” is on how to “break through” to the Target by ringing their phone on a subsequent call, or allowing them to manually set the priority of communication (at least from their point of view) so that the communication is signaled to the target only if the priority is sufficiently high;
c) Do Not ring the phone for users of Priority (Med) and send a message that indicates that the Target user is “unavailable” and will return the call in the future; and
d) Do Not Ring the phone for users of Priority (Low), and do not send any follow-up message other than the normal voicemail prompt.

The target can set the call disposition in various manners. For an explicit setting, the target user can explicitly set how the application handles calls of any priority and originator. For implicit setting, the application can learn what the user actual does when calls of a certain priority arrive while the target phone is in a certain state.

### 4. Information Sharing Between the Calling Parties.

Information can be shared by the originator to the target, and from the target to the originator. For data or information from the originator to the target, when an originator attempts to call the target's phone they may elect (assuming they have the same Communication Priority application installed) to share their priority rating of the target. The target can adjust the relative priority of the originator using this information, should the target user elect to implement that feature.

Additionally, the priority that the originator has established for the target can be displayed during the caller-ID interval on the Target's device. For example: “John Smith is Calling, His Priority for you is High, Your Priority for him is Med”. The originator may also explicitly define the estimated priority level of a specific communication request, and the target device may display this or use this information to modify the disposition from how it would handle it otherwise.

For situations where the target communicates to a to calling party, the Information that gets transmitted from the target to the originator is related to both the priority of that Originator, the “state” of the target and the disposition settings that create a logic map between priority, state and disposition.

For example as discussed in section 3 above, calls with the highest priority will likely get more specific information about the target's “state” and then be given a choice to break through and ring the phone. Originators with decreasing priorities will get less specific “state” information, including no message at all at the lowest levels.

In an alternative embodiment, priority classes are not linearly defined in one dimension for all aspects, and so the level of intrusiveness determined to be used for a specific communication request may be unrelated to the amount of information shared with the originator. For example, the target's supervisor at work may have a very high priority for breaking through to alert the target, but may get no information back on the context of the targets personal life and why they may not be able to receive the communication, or they may get a standard, all-purpose acceptable response that the target is simply “unavailable”, rather than “watching a movie”.

### 5. Determination of Communication Modalities and Appropriate Responses.

There are several forms of communication modalities that can be used Originator to target. The originator could be attempting to communicate with the target via regular carrier voice call, SMS, MMS, VoIP Service, Video Call, Video Message, Voice Message, Voice Alert, push to talk, or the like. The application has the logic to create the correct disposition for any of these communication modalities according to the target's state, originator's priority, originator's estimated priority for the specific communication (if supplied) and disposition setting.

For target to calling party, the target can elect to match the communication modality of the originator, or can choose to communicate with the calling party in an alternative modality. For example if a high priority carrier voice call is attempted, the target can communication their state with the originator via SMS, or any other different communication modality. Alternatively, the application can have network-based servers that communicate a similar message in a generated voice manner back to the originator in a matched communication modality. The target's logic for disposing of the call may also change the modality from one level/form of communication to a lower one. For example, it may transform a video call to a voice call, or downgrade it further to a text chat, provided the originator accepts the alternative form.

6. Set-Up and Management Wizard

In one embodiment of the application, a set-up wizard is provided and an ongoing management wizard is provided to enable the target to manage all of his application settings in an efficient manner. Because the system described can result in a lot of possible dispositions to communication requests to different originators under different circumstances, there is a degree of automated adapting to capture these settings, and this wizard allows the user to look at all the settings and logic and make explicit changes if needed, and to group such settings in ways that make it easy to manage. Appropriate settings that most users or for certain types of users can be made the default to avoid a large amount of setup effort for the user.

In one embodiment of the invention, an originator attempts to place a voice carrier call to the target. The target has previously set that the priority of the originator to “High”. The “State” of the Target is “busy”, for example in a business meeting. The disposition logic is set to set the ringer of the target phones on silent in this “State”. The originator caller gets a text response when they try to call this target. The text response will inform the calling party a text message that says that the person they called is not receiving calls due to being busy in a business meeting. The originator of the call will also have their call transferred to voicemail to leave a message. The text message will provide specific information that the target is in a business meeting and give instruction on how to break through and ring the phone is this is an urgent matter. If the device's calendar knows the duration of the meeting, it may even (should privacy settings allow) let the originator know when the meeting is expected to be over, or when the target may next be free to listen to the voice mail or to return the call.

The originator can cause the phone to ring on the original or subsequent call through three example mechanisms. For a High Priority call back, if the Originator of the call is on the called party's high priority list and if the target gets two calls from that person within a 5-minute span, then the phone will ring on the second call. The text message to the Originator will inform them that a second call will “ring” the phone, if this is an emergency.

In one embodiment, a Post Call Text Announcement is provided. The originator will receive a text message from the called phone informing them that the phone is on “silent due to a business meeting”. The text message will give the caller a specific code to text the phone to turn the “ringer” on. The originator can then send that code in a text message to the target's phone. Upon receiving that code, the called party's phone will “arm” the ringer for a period of 5 minutes for calls that are received from that specific number. The Target's phone will also return a text message to the originator informing them that the ringer is now “armed”.

In one embodiment, a Pre-call Text Announcement is used. The Originator sends a text message to the Target that they intend to call that target, and that text message has a special code that “announces” to the phone that an incoming VIP call is about to be originated from that high priority number, then the phone will be “armed” to ring for a 5 minute period on a call from that number. Only numbers that are on a high priority can “arm” the ringer for an incoming call

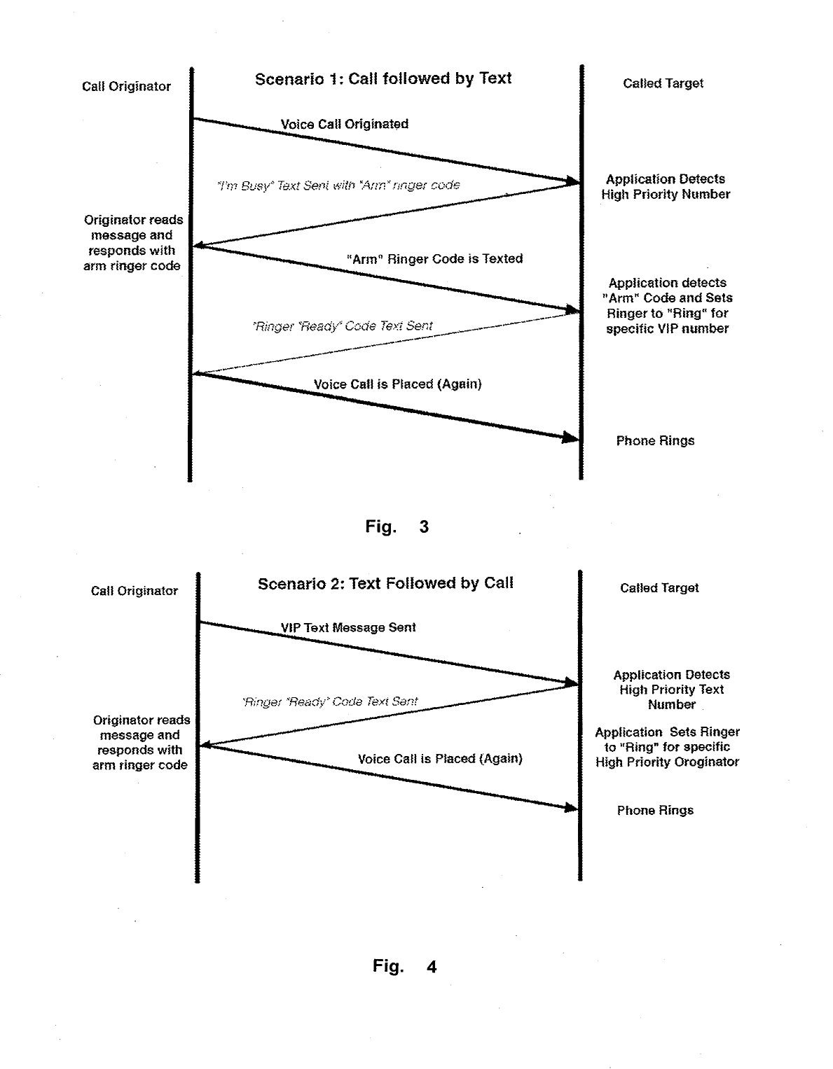

As shown In FIG. 3, a call is received from a high priority caller. If the user's phone is in a do not disturb mode, the caller receives a text and the user's phone is reset to receive a call from the high priority number for a preset period of time. When the high priority caller recalls the user, the phone rings and the call can be answered.

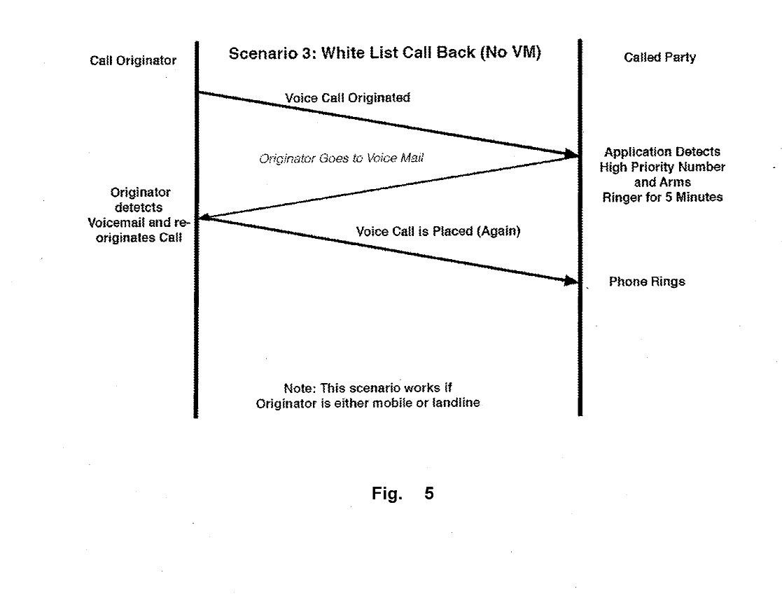

As shown In FIG. 4, a text is received from a high priority caller. If the user's phone is in a do not disturb mode, user's phone is reset to receive a call from the high priority number for a preset period of time. When the high priority caller recalls the user, the phone rings and the call can be answered.

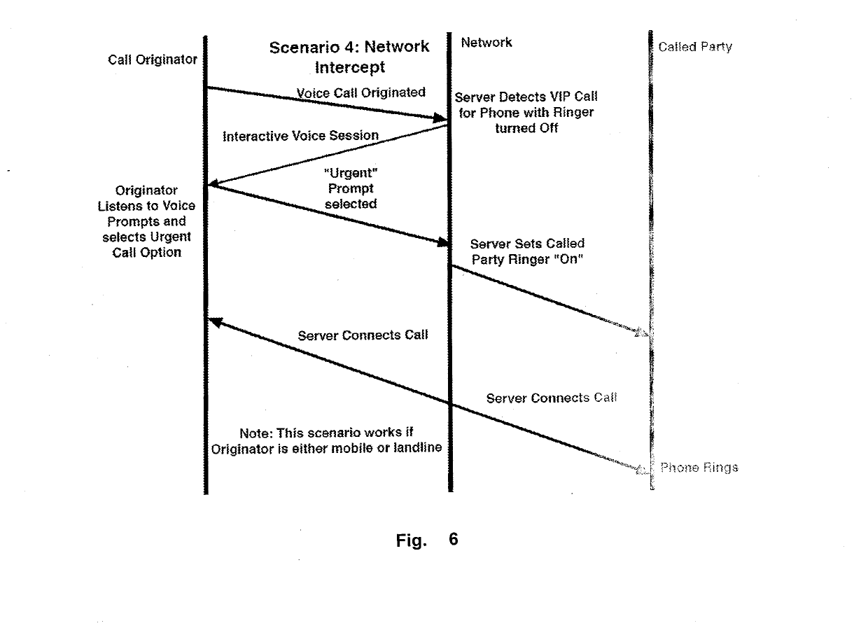

As shown In FIG. 5, a call is received from a high priority caller and the user's phone is reset to receive a call from the high priority number for a preset period of time. This high priority caller initially is sent to voicemail. If the high priority caller recalls the user, the phone rings and the call can be answered.

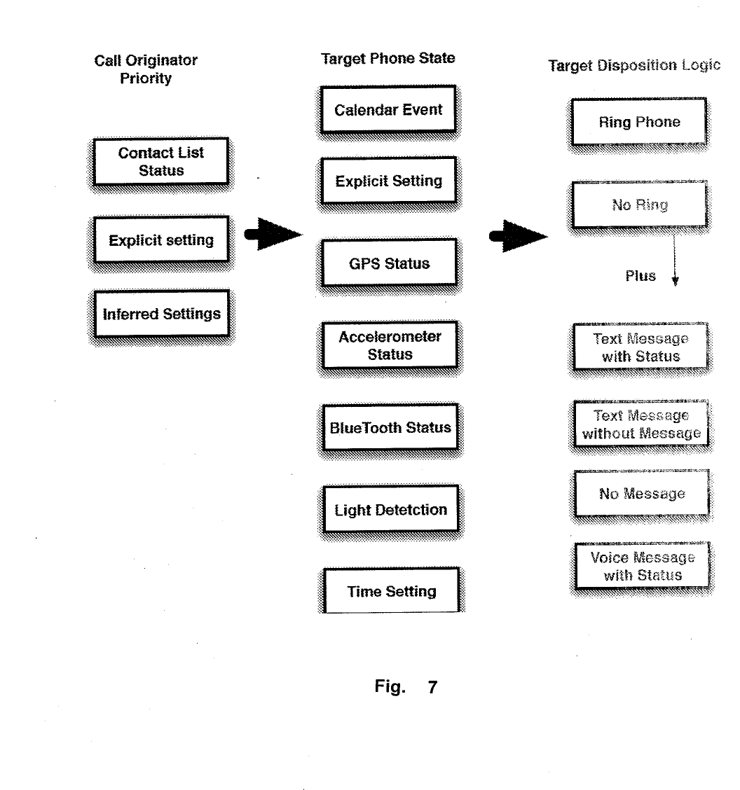

As shown In FIG. 6, a call is received from a high priority caller. The user's network determines that the user's phone is off or in a silent mode. The network then provides the caller with options regarding the urgency of the call. The caller can then select urgent and the user's phone is reset to receive a call from the high priority number. When the high priority caller recalls the user the network connects the call and the user's phone rings and the call can be answered.

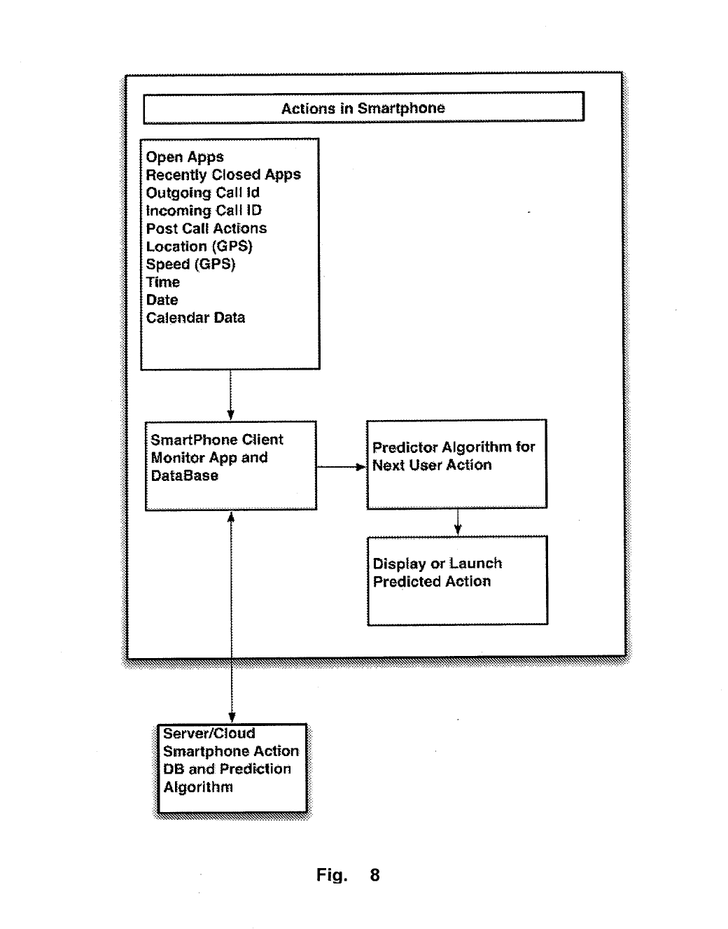

FIG. 7 is a decision tree used to determine if a user's phone should be activated to receive a call or text. The call originator priority related to an express setting, a contact list status, or an inferred setting. The target phone state is determined based on one or more device setting or statuses. Once it is determined if the phone will ring or not, a decision regarding alternate messaging such as a text is made.

During the day, different applications are used or initiated by a user. Commuting related applications may be accessed in the morning or evening, along with weather forecasts. In one embodiment, an application monitors and records device activity. The device preferably includes a processor and a memory coupled to the processor. The application is stored in the memory and causes the processor to execute the disclosed method. The activity includes the specific applications that are launched, used, and active at a specific time as well as their usage over time. When phone calls, text messaging patterns, GPS/location, or other activities occur, etc., the phone usage establishes a pattern of use based on time, day, location, other available contextual data, and recent user activity. As the predictor application records the various phone and user activities, it creates a predictive use model and makes intelligent recommendations to the user for the application that is most likely to be needed next.

In one embodiment, after receiving a phone call from a specific Caller ID, the user often opens a calendar application. The predictor application would note this pattern and place the calendar application icon on the screen, preferably in a highlighted “suggestion corner”, automatically following that specific call.

If the user always plays a game, for example “Angry Birds” at a specific time of day, that the predictor application places that application icon on the home screen at the specific time. Similarly, if the user always sets the device to vibrate when at a certain location, the predictor app can learn this behavior and automatically set it for the user.

Another example is if the user usually opens up a mapping/navigation application, the GPS system of the device recognizes that the user has left a specific location and has gone a car. The navigation application is then suggested.

Over time, as a usage pattern is learned and established, the predictor application is configured to suggest applications or services and activate them for the user, if the user allows for automatic suggestion activation whenever the confidence level is over a specified amount. In a preferred embodiment, the learning behaviors are dynamic and change with time as the user's pattern is altered.

In one embodiment, the user can activate a “pause-learning” mode in cases where the user goes on vacation or does something that is not a frequent behavior. In this manner, a non-typical action is not learned and subsequently suggested.

In one embodiment, an alternative mode of operation is available whereby options are presented that typically would not be. For example, if the GPS detects that the user is not in a typical location, the navigation application is launched.

In one embodiment, the Smartphone client maintains a local database of phone activity and interacts with a local learning algorithm for making predictions and suggestions on the next phone action. In one embodiment, a local database analyzes data provided by the device and launches relevant applications because of the analysis.

Additionally, the device client will interact with a networked database that will aggregate the activities of multiple devices. The aggregated network data, along with a network prediction algorithm can be used to further refine the local client results and can also serve as an interface to advertising and application promotion networks to enhance the suggestion to products/services and applications that are not on the client device.

There are many appropriate machine-learning algorithms that can learn a user's behavior, such as decision trees, or neural networks. However, the machine learning research community has frequently found using Bayesian Networks in this type of problem to learn patterns to be the superior method and is our preferred embodiment.

In one embodiment, the “suggested application” is a “sponsored application” that is triggered by a combination of what the user most likely might want next, and what advertisers might want to influence the user to do next. For example, if the device learns the user usually leaves the office for lunch at noon, the suggested/sponsored application at 11:45 am can be set to a review for a nearby restaurant that pays for such preferred influence.

In another embodiment, more than one suggested application is displayed to the user, ordered from most likely to least likely to be launched. In another embodiment, if the user doesn't want to start the suggested application, but thinks the predictor will likely get the suggestion right on the next try, the user can “swipe” the suggested application off the screen with a hand gesture, in the case of a touchscreen, in a direction not yet reserved by another function and then the suggested application will be replaced by the next most likely suggestion. Other key functions can be used to remove the application.

In one embodiment, the system and method are embodied in a Mobile Smartphone. The application resides on a Smartphone device for sending original video, recording reactions, and viewing reaction videos. For a tablet, the application resides on a Tablet device for sending original video, recording reactions, and viewing videos. For social media sites, such as Facebook, the application resides on the social media site i.e., as a Facebook application, for sending original video, recording reactions and viewing videos. A web Based application would reside as a “Flash” Web based application for sending original video, recording reactions, and viewing videos. Kiosk based applications reside within a Kiosk in interacts either with other Kiosk or other Web connected devices (Phones, Tablets, Computers, etc.). A cross platform embodiment is conceived in which any message can originate on any other the named platforms and interact with users on any other names platform.

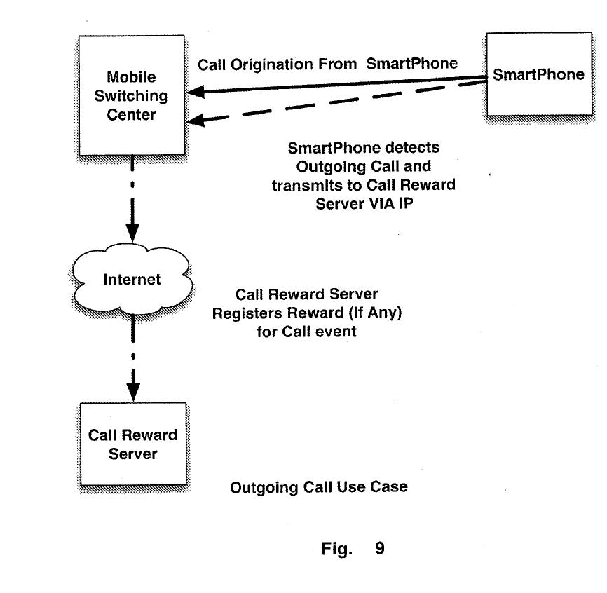

As shown in FIG. 8, a smartphone client monitors the actions or applications activated in a smartphone. This activity is stored in a memory. A predictor algorithm is used to predict a next user action. Based on this prediction, the user is presented with a display for the application or the predicted application is launched. In one embodiment, the application predictor is maintained on a server or in the cloud.

One embodiment of the present invention is a system and method for rewarding specific smartphone usage. As applications are used and launched, users can be rewarded for such use. Additionally, for applications that rely on advertisements for revenue, the more a user uses the application the greater the potential revenue stream. Therefore, it is advantageous to reward application usage. Additionally, certain call types can earn rewards.

In one embodiment, an application is provided that that detects call events and transmits the call events to a central database. A user account is maintained in the centralized database, which is updated with the user's call events. The central database provides rewards to the user based at least in part on the user's specific call activity. Generally, the phone call, either originating at the smartphone or terminating at the smartphone, is the basis for the reward program.

Generally, both the user and advertiser or other reward grantor registers with a call reward server. Users register to receive points, rewards, and the like and advertisers or other reward grantors register so that specific calls can be awarded points. The point awards entice a user to participate in calls that may be avoided.

Users are rewarded for accepting certain types of calls, for example political polls and product/service advertisements. Not all calls from all numbers have to be rewarded. The centralized server/database can selectively reward call activity based on frequency of use, call type, calling number, time of day, etc. Further, the call for which the award is given must be registered with the award system.

The application detects all mobile originated and mobile terminated calls on a smartphone. Once the call is detected the application sends a message to a central server that registers this event. The data is sent via the phone's internet connection, not the existing mobile signaling paths that actually manage call control. The purpose of registering these events is to reward the consumer with “points” for call event. While rewards are disclosed as points, any reward is possible.

The consumers call point account can be retrieved by the consumer either directly through their Smartphone or through any other Internet connection that they then authenticate by entering their username and password at a call reward server Web site.

In one embodiment, the points are convertible through various marketing programs into items of value. For example, items of value might be credit on your pre or post pay phone bill, discounts for electronic or physical merchandise, or gift cards, or direct cash as a check or electronic funds transfer.

The application has the ability to detect the call events and transmit them to a central database, maintain a user account in the centralized database, and provide rewards for the users based on their call activity. While device side applications are preferred, a network solution can be implemented that monitors call activity at a switching station or other routing location in the telephone network.

Rewards can be earned for specific events. For example, a phone is provided with an advertisement. In this case, the advertiser pays the reward to the user for viewing the ad. In one embodiment, phone calls from specific numbers are rewarded. Examples of these calls are polls, solicitations for donations services products and the like, and other notifications. Further, phone calls to specific numbers are rewarded. Examples of rewarded calls made include certain product/service call centers, phone calls to contest lines, such as American Idol voting. In this case, the user hears an advertisement on the phone prior to voting. In one embodiment, calls to call centers that make users wait a long time are rewarded calls. In this case getting a “reward” offsets the users “annoyance” of waiting.

FIG. 9 is a flow diagram for an outgoing call. A smartphone user originates a call that is processed by a mobile switching center. The application monitors the outbound call and determines if the call is a reward call. If the call is a reward call, the smartphone transmits reward call data to the call reward server. In a preferred embodiment, the data is transmitted to the call reward server via an Internet protocol (IP).

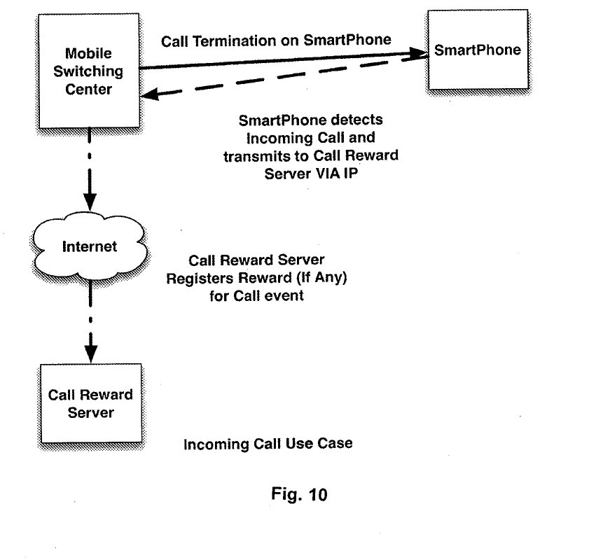

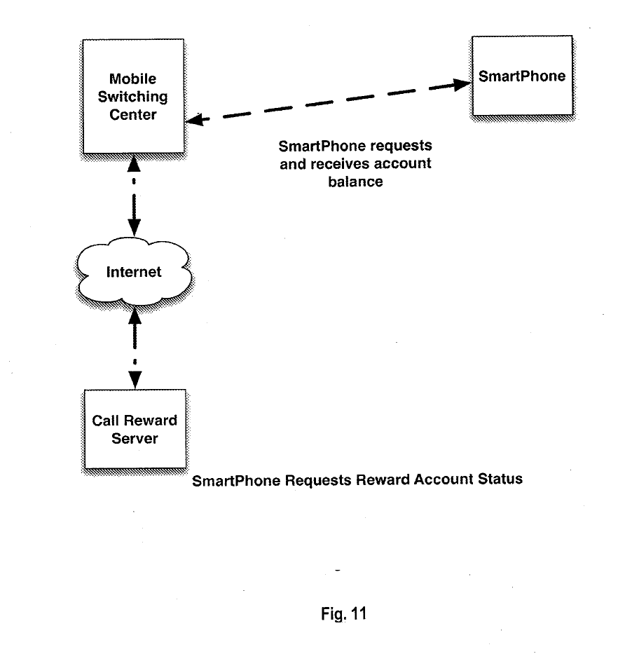

FIG. 10 is a flow diagram for an incoming call. A smartphone user receives a call that is processed by a mobile switching center. The application monitors the inbound call and determines if the call is a reward call. If the call is a reward call, the smartphone transmits reward call data to the call reward server. In a preferred embodiment, the data is transmitted to the call reward server via IP.

FIG. 11 is a flow diagram for a reward request. As the application monitors the inbound and outbound reward calls, the call reward server collects the reward call data. The user is able to access the call reward server using the application or via the Internet. The user's call reward balance can be monitored by the user and rewards earned.

In one embodiment, the monitoring occurs at the mobile switching center. The monitoring at the mobile switching station can monitor both inbound and outbound calls.

It should be noted that the application predictor can be set to favor applications that can earn rewards. Likewise, the priority management system can be set to accept calls that earn rewards.

Another embodiment of the invention includes an application that is adapted to run on the device. The application is stored in the memory and causes the processor to execute the steps of the process. In one embodiment, the application is a server side application that collects at least a user's private social ordering and provides content based on the ordering. Further, application that collects like/dislike votes and provides content based on the votes. User activity can be monitored to enhance and refine the selection of delivered content. Alternatively, data is collected and aggregated locally and this local data is used to request or filter content upon delivery.

Typically, user participation is required, specifically the user liking and disliking content or providing a private social ordering. In one embodiment, a designation (like/dislike) is automatically assigned within social media sites based on whether a user actually clicks and reads a specific post. One method of automatically assigning a designation is to assign “Like” to any story or item that is clicked-on and assign “Dislike” to a story or content that is bypassed.

This system and method provides a mechanism for a user to select “like” and “dislike” preferences regarding the people in their social network and/or contact list as well as the content they provide. This selection acts as a basis for the user's private social ordering. This selection is preferably separate from a like/dislike selection on presently presented on social media sites. In one embodiment, the like/dislike selection presently presented on social media sites triggers the application to capture the selection. The selection or voting is collected at a central location and analyzed for future content delivery. The preferences can take into account how much interaction or communication with each person is liked/disliked, how much the person is liked/disliked, or how much the social media content from a person is liked/disliked relative to the others in the user's social network.

In many social media applications, for example Facebook, Twitter and LinkedIn, there is no function to dislike a person or a specific post. The social stigma of publicly disliking a friend, colleague, or specific post is not available. This application permits a “secret” dislike of a specific person or post. In other words, the user disliking a specific person, post, or item is maintained in secrecy. The purpose of the dislike is to feed an algorithm made available to the social networks that would reduce the number of similar posts that the user would receive. Similar to the manner in which Pandora adjusts your personal internet music channel by allowing you to like or dislike specific songs, this app is applying this principle to social media.

In one embodiment, the application provides like/dislike functionality to web sites being browsed. Specific items on a web page can be liked or disliked. For example, if a user is reading articles on a news site, specific articles can be liked or disliked. A keyword analysis of the news article will be performed and this analysis will be used for future content delivery. A similar analysis can be performed for pictures. In one embodiment, tags associated with pictures are used for the like/dislike analysis. For example if stories about hockey are liked, the user will be exposed to more stories that are similar. Similarly, if the user always dislikes stories about travel, then fewer of those stories will be presented to the user.

In social relationships, there is a natural social ordering to the social importance of each person connected to a user. This ordering from Most Important or Most Liked to Least Important or Least Liked is generally maintained in private and not because of the social conflict it would cause. However, if this information were known privately and securely by the underlying technology we use to communicate with and mediate these social relationships, the technology can do a better job of such mediation and prioritization. In other words, content form those relationships that have higher social importance is more likely to be relevant than content form those relationships that have lower social importance. The present application can provide structure and order to communications based on the person's social status with respect to the user. If a user continually dislikes messages, posts, content, and the like from a particular person, both the content and the user will have a lower rating than a particular person whose messages, posts, content, and the like are liked. Using the present application, the disliked content is blocked and that person's rank or rating is lowered.

In one embodiment, the application interacts with general media sites, for example a site such as CNN or the NY Times. By allowing the user to like/dislike stories, the media site could create a real-time, interactive, and personalized presentation of their product for each user. News aggregation sites attempt to do this by allowing the user to select the specific publishers to be displayed. The present application provides further refinement and adjusts the content that the user views by their stated preferences.

The mediating technology can use this privately known social ordering to perform such functions as:

choose an alert level to notify the user, such as loud and friendly ringtones for a call from a highly-valued social connection, vs. a vibrate or silent alert to a call from someone very low-valued social connection;

ordering the user's contacts by social level for such things as invitations or finding the most valued people more quickly in a long contact list;

automatically mediating and sharing private information to very important people in a user's life that they would not share with less valued people, such as location, reasons for not being currently available, or calendaring information;

prioritizing which messages to respond to or look at first, or

reminding the user to respond to messages from well-liked people if a certain amount of time elapses without a response or acknowledgment of some kind.

In one embodiment, social standing can be automatically learned, adjusted, or inferred from such data as communication frequency, response time to messages, how often calls are picked up, what time of day communication is engaged in, and other indicators of how well liked or not a person is to a user.

An advantage of this technology is that it allows a user to express their degree of liking someone when it may not be prudent to do so in a public manner, or even to the person liked, such as in a business setting. Further, the user can express dislike, and vent to their technology instead of being overtly rude or hostile to the other person, creating a more civil interaction for society.

The present application can be applied to a plurality of interactions and activities. As discussed above, posts and messages from persons using social media sites can be filtered using the present application. User assigned preferences are explicitly provided by selecting like/dislike or are implied from viewing. For advertising, if a user likes an advertisement, more advertisements for the product are presented to the user. Alternatively, if it is not the specific product but the style or format of the advertisement that the user is drawn to, the application can discern this difference and present the user with advertisements in the preferred style. For media sites, the application can personalize a newspaper, TV, or the like and deliver desired content. For entertainment sites content is presented based on a user's likes and dislikes and further refined based on continued activity. For cable television as a user likes or dislikes shows, an aggregated channel of TV shows that appeal to the user can be presented on a channel or arranged for your own ON-Demand area.

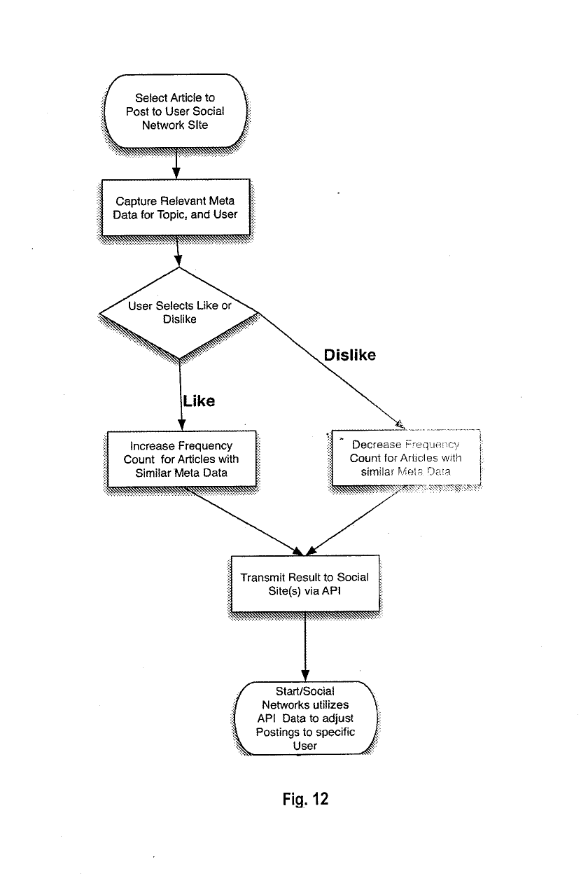

FIG. 12 is a flowchart for the private like and dislike. As the user receives information the user categorizes the information as a like or a dislike. The like or dislike categorization is transmitted to a social media site. This data is then used to adjust postings to specific users by filtering or other algorithm.

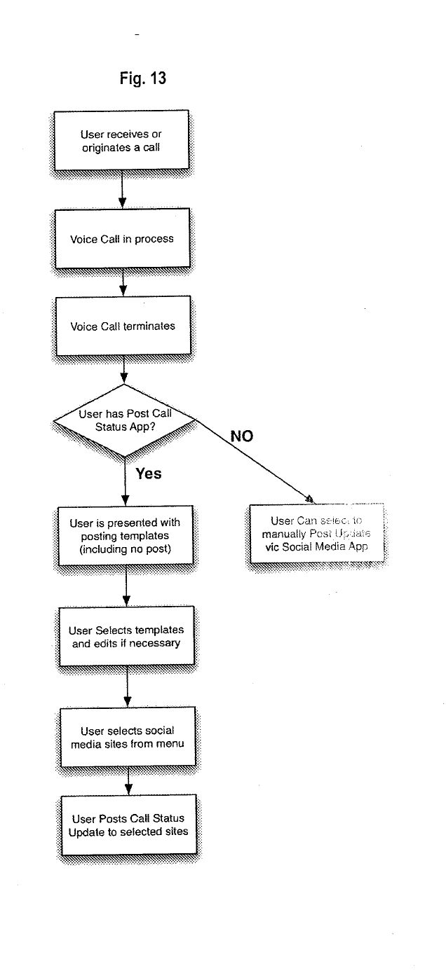

Another application is provided that updates call event status to social media sites. In one embodiment of the invention, as shown in FIG. 13, a user receives or initiates a phone call. While the present embodiment is described with respect to a phone call, typically on a mobile device, other communication protocols such as a video call, chat, text, or the like to any manner of device configured for communication are contemplated. The communication proceeds and eventually terminates. Upon termination of the call, or other communication protocol, the application presents the user with posting templates. The posting templates include, but are not limited to, generic social media templates, FaceBook status updates, tweets, myspace updates, and the like. One template option presented to the user is a no post option. The no post option can be a radio button, a check box, or the like.

When the user decides to post an update via social media, the template is provided to the user. The template is edited as necessary. In one embodiment, the template initially includes relevant information regarding the call, including but not limited to participants, duration, and the like. The application detects the other party of the phone call through the users contact list or user ID. For example the template embodiments could be: “I just finished a great call with John Smith” or “John Smith and I just spoke for 34 minutes” or “John and I just spoke about” (User fills in the rest). Alternatively, an appropriate template is for a social media site is selected. The template is edited as necessary.

Other updates can include, but are not limited to, a doctor postings instructions to a private social media site for his/her patients after a call, call in contest lines that post a winning caller on their social media site as a way to drive site traffic, and consultants/lawyers posting call durations to a billing system to automatically register client billable time.

In one embodiment, the template initially includes relevant information regarding the call, including but not limited to participants, duration, and the like.

The user selects a social media site. In one embodiment, the social media sites that the user is a member of are presented on a drop down menu. The user of the app is presented with a clickable option to post these messages to a registered social media sites. Preferably, user logins and passwords are stored in the device memory and accessible so the user does not have to enter the login to post the update.

Once the user finished editing the template as desired, the update is posted to the selected social media site. Preferably, multiple social media sites can be selected so one template can access and update multiple social media sites.

In one embodiment, a phone call is initialized within a social media application. For example, a direct calling capability within Facebook. At the completion of this “Facebook” voice call, the user is then presented with the template option to post the call status on Facebook.

In one embodiment, an IP voice call from a service such as Skype from a computer, tablet, or mobile device is initiated and completed. The application detects the presence of the IP voice call and then presents the same post call calling options to the user, regardless of their device.

Another embodiment allows the user to use a touchscreen while taking the call on a headset to start to construct a more elaborate social media package documenting or related to the content of the call. It might be notes about the content of the call, photos, a to do list of action items, etc. Then when the call is over, the package is posted to a social media site, publicly or privately.

Another embodiment is the social media post as a “social reward” to thank the other caller for their time spent on the call and thereby reinforce the process as a standard etiquette. The social reward might be an e-thank you card, social media credits of some form, or game credits or other virtual goods or socially valued commodities, such as a “rating” for the caller that gives them status as a great conversationalist on the phone, as they accumulate more high ratings.

It should be noted that as rewards are earned for call activities those rewards can be submitted to the social media sites.

At the end of the day, after a full day using the device, the user must finally go to sleep. In one embodiment, an application is stored in the memory and causes the processor to execute the steps of the process to enhance or aid in inducing sleep. In one embodiment, the application is a server side application that collects sleep data as discussed below. Additionally, user activity is monitored to enhance and refine the ease with which a user falls asleep using the application. Data is collected and aggregated and this data is used to suggest applications that will aid in a user falling asleep.

The preferred embodiment is an application that is resident on a smartphone or tablet device. However, in one embodiment, the application is a function loaded onto hardware devices such as computers, home controllers, e-readers, alarm clocks, radios, TV's, alarm systems, PDAs, and the like.

In one embodiment of the invention, a program for senses a user's sleep patterns and provides responses that are sleep conducive. A preferred embodiment of the invention is a mobile phone application that senses whether a user is sleeping. The sensing operation obtains several measures from several sensors to improve its accuracy. Those sensors could measure one or more of (i) reduction in user activity; (ii) no device movement (as sensed by the mobile phone's built in accelerometer); (iii) a change in the ambient light conditions; (iv) a change in the ambient sound levels; (v) inputs from a remote sensor (such as an alarm clock, a home controller, or a home alarm condition); or (vi) manual settings. It should be noted that most smartphones have sensors that can be adapted to provide relevant data such as the ambient light, relative motion of the device, and the like.

Once a sleep condition is determined, the application can trigger one or more functions that are sleep conducive or sleep enhancing. The triggered tasks include one or more of (a) changing the light frequencies associated with the mobile phone display so that blue light spectrum is filtered out; (b) activate white noise playback; (c) mute certain device operational sounds or lower/minimize volume settings; (d) place the mobile device in a forced sleep mode; (e) replace display with a pattern that is sleep promoting; and (f) activate a phone management module that sends out automated messages, blocks all but important incoming calls, and controls aspects of the surroundings (e.g. engages with home control systems to dim lights, change temperatures, lock doors, arm alarm systems, and the like).

One embodiment of the invention manages and moderates a user's sleep cycle using a device, typically a mobile device, preferably a smartphone or tablet device as a “sleep coach”.

The theory of how the mind is guided more rapidly into a sleep cycle includes the following principles: physiological principles, circadian rhythm, stimulation, and environment.

A sleep cycle is at least in part dependent on a buildup of adenosine in the brain that is the result of a breakdown of adenosine triphosphate (ATP) over the course of the day. ATP is known as a body's carrier molecule of immediate energy. As ATP is used, the phosphate groups are pulled off until free adenosine remains. As adenosine levels rise in the brain due to its energy usage, they inhibit neural activity, contributing to sleepiness. During sleep, the adenosine is metabolized and its levels decrease until the mind feels refreshed at the end of a sleep cycle.

Sleep is also affected by the circadian rhythms of various hormonal levels such as melatonin and serotonin. Circadian rhythms, and their hormonal release, are strong when the sleep cycle is regular and repeatedly occurs during the same daily time period, and become weaker when it changes to different parts of a 24-hour day. Further, there are known influences that moderate and shift the circadian rhythm, such as blue light receptors in the retina, which when stimulated signal to the brain that it must be daytime due to the “bright blue sky”. Another influence is time of first meal in the morning, signaling to the brain this is the time in the day to get up.

Countering the body's natural sleep cycle and general sleepiness are the brain's arousal and stimulatory circuits and hormones, such as adrenaline. The brain self-stimulates and maintains arousal when strong emotions are present, and/or the self-narrative “voice” in the head continues to actively speak. Anything that soothes and calms emotions, or that encourages the brain to end its self-initiated internal chatter, will help sleep arrive.

Another standard technique to enhance or enable sleep is to maintain a consistent environment during a sleep induction time period. This constant environment takes advantage of the brains associative abilities to associate that context with it being time to induce the sleep state of the brain.

One technique to moderate a sleep cycle uses the time spent utilizing various smartphone and tablet applications prior to retiring the device for the night, typically prior to going to sleep.

In one embodiment, the system monitors application session time measurements. These measurements are sent to a central server to categorize apps as either sleep inducing or sleep depriving. An application that frequently has a long session time prior to night time retirement would be considered sleep depriving as it acts as a stimulant to the brain, thus keeping the user awake longer. An application with a frequently short usage time would be considered a sleep inducing application. The central server will maintain a statistical database of application usage and derive a pattern of usage for both the specific individual as well as the general population.

The device application, once a critical mass of data is garnered, can either make recommendations to avoid certain applications at bedtime, or could be coupled with a “Parent Mode” that actually locks out sleep depriving applications and only allows those helping induce sleep.

Applications that help induce sleep are cognitively taxing—those that require a lot of energy usage by the brain and thus rapidly increasing adenosine levels, while not stimulating the brain and exciting the arousal circuits and hormones. Reading an e-book that is very “dry” with cognitively challenging text that is not stimulating in any way works well for this. Similarly, playing a game that is very taxing to the mind, but does not stimulate the user via timing and a rush to complete the game, or that has violent or stimulating imagery can work well.

While some activities on a mobile device may assist some users to fall asleep, it may be too stimulating for other users, and this is why there is a need to monitor what works for each user and personalize the recommended app for each person. Because this system is used right before falling asleep, it is a very difficult time for a user to stay aware of what activity was most helpful or to do measurements of which application was more helpful than another over the course of many nights.

The application on the device can issue a “warning” if a brain stimulating (sleep depriving application) is launched after a specific time.

The centralized database could be further exploited by creating a “Sleep Index” rating system that a device user can query to determine the appropriateness of an application prior to bedtime.

Another way the system helps the user sleep successfully is by tracking a user's circadian rhythm over time, and encouraging the user to stick to a regular 24-hour cycle. Sometimes this can be used to help a user overcome jet lag from a large change in time zones as well. A countdown can begin for the user when it is time to begin nightly pre-sleep rituals in order to fall asleep at the same time as the previous night, or according to whatever sleep schedule the user sets up (or parent sets up) as the desired schedule. The more rigid the sleep schedule, the stronger the hormonal surges will be to induce sleep.

One way mobile devices are currently affecting sleep patterns in a negative way is by filling up the retina with strong blue light at the wrong time of the day (night). As an alternative to that, when the system herein is in a mode to be encouraging sleep, it turns off blue pixels in particular and reduces brightness as much as possible overall. If an application (or say, a video) normally requires blue pixels to be viewable, an automatic color remapping can be done that maps the three dimensional RGB color space onto the two dimensional RG space by optimizing for contrast and the most similar to the original colors possible while still conveying as much of the original view's information content as possible.

Some sounds are stimulating, cause arousal, and others either drown out distracting sounds, and help induce sleep. Some sounds, if played every night when successfully falling asleep, help remind the brain that it is time to fall asleep. Sound levels of an app should be turned as low as possible, unless sound is being used specifically to induce sleep, in which case the system can learn which sounds help induce sleep in the same way it learns which apps help induce sleep, across users and for a particular user. This also helps the user when the sound is consistent from night to night because of the principle of the brain's associative abilities. Similarly, if a particular app or reading about a particular subject is used every night when sleep arrives this teaches the brain to associate that activity with falling asleep and becomes more powerful the more it is repeated.

One embodiment of the invention is an app designed to do all of the above specifically together—activities designed to be interesting enough to be cognitively taxing and boost adenosine levels, distract the mind from internal chatter, but with no blue pixels, sleep inducing sound, or arousing or overly stimulating content.

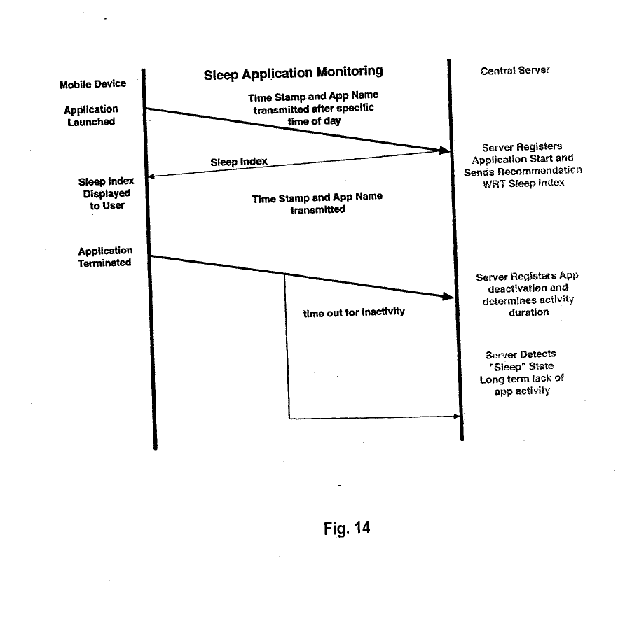

As shown in FIG. 14, once the application is launched a time stamp is sent to a central server. In one embodiment, the application predictor launches the sleep application. A sleep index is then sent to the device and displayed or conveyed to the user. If a time out due to inactivity occurs, the server detects a sleep condition.

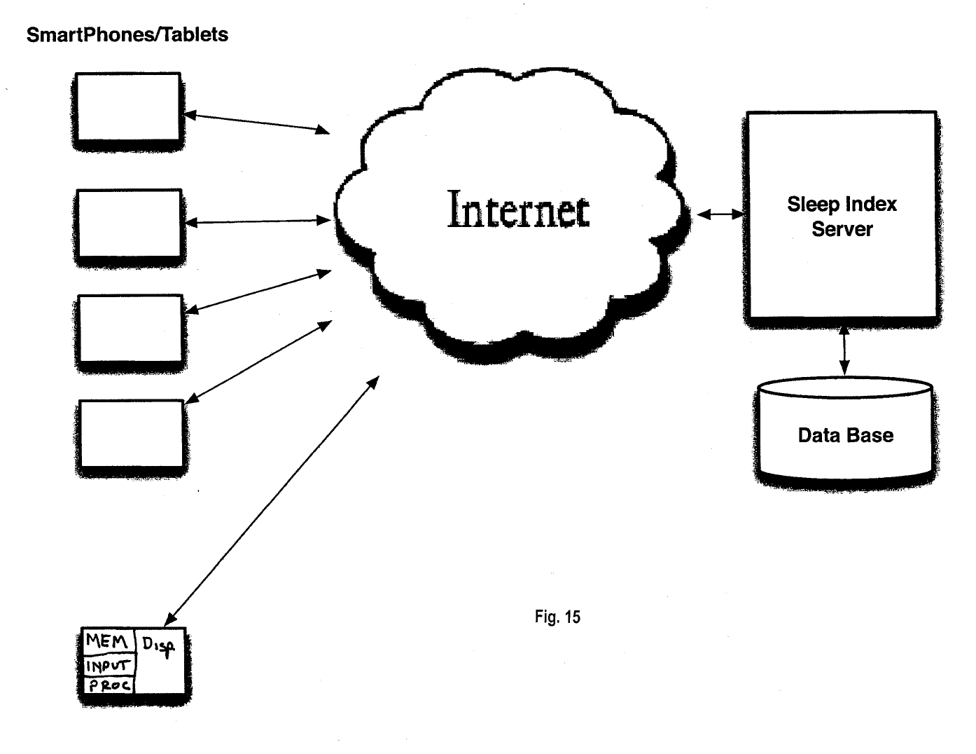

FIG. 15 shows a plurality of devices coupled to a sleep index server via the Internet. The sleep index server collects data and stored such data in a database. The sleep index server uses the collected data to provide individual users with their sleep index. The more data that is collected, the more accurate the index can be.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for predicting application use on a device, comprising:
monitoring a user's activity on the device; and
one of preloading an application in a memory of the device based at least in part on the monitored activity and displaying an application launch icon in a launch area of a display of the device based at least in part on the monitored activity,
wherein the user's activity does not include direct interaction with the application or the application launch icon.

2. The method of claim 1, further comprising receiving an input from the user regarding application launch sequences.

3. The method of claim 1, further comprising:
monitoring a location of the device; and
launching a location based application.

4. The method of claim 3, wherein the location based application is at least one of a mapping application and a navigation application.

5. The method of claim 1, further comprising:
receiving aggregated usage data from a plurality of users,
wherein the one of the preloading the application and the arranging the application launch icon is based at least in part on the aggregated usage data.

6. The method of claim 1, wherein the application is a sponsored application.

7. The method of claim 1, wherein at least one of a plurality of applications are preloaded and a plurality of application launch icons are displayed in the launch area.

8. The method of claim 7, wherein the user ranks the plurality of applications.

9. The method of claim 8, wherein future preloading or displaying of launch icons is based at least in part on the user's ranking.

10. A method for enhancing sleep patterns using a device, comprising:
determining by the device if the user is sleeping or preparing to sleep; and
triggering a sleep conducive task on the device.

11. The method of claim 10, wherein the sleep determination is based at least in part on one or more of:
reduction in user activity on the device,
no movement of the device;
a change in ambient light conditions;
a change in ambient sound levels;
an input from a remote sensor; and
a manual setting entered by the user via an input of the device.

12. The method of claim 10, wherein the sleep conducive function include one or more of:
changing light frequencies associated with a display of the device to filter out a blue light spectrum;
activating a white noise playback;
muting device operational sounds;
lowering volume settings;
placing the device in a forced sleep mode;
displaying a sleep promoting pattern; and
activating a communication management module that sends out automated messages and blocks at least some incoming calls.

13. The method of claim 11, wherein the reduction in activity or movement is determined by the device's built-in accelerometer.

14. The method of claim 10, further comprising:
receiving aggregated sleep data from a plurality of users,
wherein the triggering of the sleep conducive task is based at least in part on the aggregated usage data.

15. The method of claim 10, further comprising providing an alert to the user if a stimulating application is launched after determining the user is preparing to sleep.

16. The method of claim 10, further comprising providing an alert to the user if a stimulating application is launched after a predetermined time of day.

17. The method of claim 10, further comprising at least one of:
blocking a stimulating application after a predetermined time of day or is launched and
blocking the stimulating application after determining the user is preparing to sleep.

18. The method of claim 10, further comprising creating a rating system based on a stimulating effect of an application.

19. The method of claim 10, further comprising tracking the user's circadian rhythm over time.

20. A method for operating a device comprising:
(1) verifying a user comprising:
storing an authorization picture in a memory of the device;
activating a camera;
capturing at least two different pictures using the camera;
comparing the at least two different pictures to the authorization picture using a processor of the device; and
verifying the user for access to the device when the at least two different pictures substantially match the authorization picture;
(2) managing communication priorities comprising:
creating at least two priority classes for communication partners;
assigning a priority class to each respective communication partner;
determining a status of the device; and
determining a communication modality for the device based at least in part on the status of the device and the priority class of the respective communication partner;
(3) rewarding the user for device activity comprising:
monitoring by a microprocessor at least one of an inbound communication, an outbound communication, and an application usage;
determining if the communication or the application is a reward event; and
transmitting, by a transceiver of the device, reward data to an event reward server; and
(4) posting a social media status comprising:
initiating a communication;
terminating the communication;
launching a status update application;
presenting the user with at least one status template; and
posting communication status to a social media site; and
(5) providing relevant content comprising:
learning a user's private social ordering;
receiving a first content;
capturing relevant data related to the first content;
receiving a user ranking of the first content based at least in part on the user's private social ordering;
presenting the user with second content based on the relevant data and the ranking and filter third content based on the relevant data and the ranking; and
updating a ranking based at least in part on subsequent user activity.
